(19) United States
(12) Patent Application Publication
(10) Pub. No.: US 2005/0286900 A1
(43) Pub. Date: Dec. 29, 2005

(54) Intelligent modular multimedia data distribution system

(75) Inventors: E. Douglas Bentley, Auburn, ME (US); Monico Sanchez JR., Nampa, ID (US)

Correspondence Address: PATRICK R. SCANLON;PRETI, FLAHERTY, BELIVEAU, PACHIOS & HALE, LLP, ONE CITY CENTER, PORTLAND, ME, 04112-9546, US

(73) Assignee: Infinite Media Solutions, LLC

(21) Appl. No.: 10/396,255

(22) Filed: Mar. 25, 2003

(51) Int. Cl. H04B 10/00

(52) U.S. Cl. 398/135; 370/208

(57) ABSTRACT

A modular multimedia data distribution system includes a plurality of modules interconnected by fiber optic cables wherein data can be sent directly from one module to another. Each module is provided with connections for connecting the module to a media device. The system also includes a plurality of chassis, each chassis having one or more slots for interchangeably receiving the modules. Each of the slots includes connections for powering the modules and connecting the modules to a common fiber optic network. One or more of the modules may be capable of receiving signals from media devices, converting received signals into data, and sending data to at least one other module. Furthermore, one or more of the modules may also be capable of receiving data from other modules, converting received data into signals, and sending signals to a media device.

### BACKGROUND OF THE INVENTION

This invention relates generally to multimedia data distribution and more particularly to systems for distributing data to a multitude of appliances and/or other systems located throughout a building.

In recent years, the number of consumer electronic appliances found in homes has increased significantly. Now, many homes include multiple televisions, personal computers, VCRs, DVD players, satellite receivers, camcorders, audio equipment and so on. Homes and offices are also regularly provided with electronically controlled lighting systems, HVAC systems and home security systems. This expansion in electronic appliances and systems has led to demand for home (or office) automation and media distribution solutions.

Many approaches to home multimedia networks have been proposed. However, currently available systems are generally complex and difficult to operate. Many current systems also require installation of numerous cables or wires, such as one type for telephone, another for cable TV, and yet another for computer terminals. The large number of cables increases the cost of the system and also makes installation and maintenance difficult. Furthermore, adding additional devices to current systems typically requires more cables to be installed in the wall. In addition, care must be taken in locating many types of cables because of their susceptibility to electrical noise.

Accordingly, there is a need for a data distribution system that is affordable, modular, upgradeable, and simple to operate.

### SUMMARY OF THE INVENTION

The above-mentioned need is met by the present invention, which provides a modular multimedia data distribution system comprising a plurality of modules interconnected in a peer-to-peer architecture by fiber optic cables wherein data can be sent directly from one module to another. Each module is provided with means for connecting the module to a media device. The system also includes a plurality of chassis, each chassis having one or more slots for interchangeably receiving the modules. Each of the slots includes means for connecting a module to a fiber optic network. One or more of the modules may include means for receiving signals from media devices, means for converting received signals into data, and means for sending data to at least one other module. Furthermore, one or more of the modules may also include means for receiving data from other modules, means for converting received data into signals, and means for sending signals to a media device.

The present invention and its advantages over the prior art will be more readily understood upon reading the following detailed description and the appended claims with reference to the accompanying drawings.

### DESCRIPTION OF THE DRAWINGS

The subject matter that is regarded as the invention is particularly pointed out and distinctly claimed in the concluding part of the specification. The invention, however, may be best understood by reference to the following description taken in conjunction with the accompanying drawing figures in which:

FIG. 1 is a schematic view of a system for distributing data to devices located throughout a building.

FIG. 2 is a front view of a wall-mounted chassis assembly having four programmable modules used in the system of FIG. 1.

FIG. 3 is a schematic view of one of the chassis showing the modules contained therein in more detail.

FIG. 4 is a front view of a base chassis.

FIG. 5 is a side view of a base chassis.

FIG. 6 is a file table for the system of FIG. 1.

FIG. 7 is a sample signal routing list for the system of FIG. 1.

FIG. 8 is the sample routing list of FIG. 7 after a signal routing change has been made.

### DETAILED DESCRIPTION OF THE INVENTION

The present invention pertains to a system for distributing data to a plurality of media appliances and/or other systems located throughout a building such as a home, office or the like. The data distribution system includes a decentralized, multimedia network that can interconnect a wide variety of appliances and building systems such as telephones, computers, televisions, VCRs, DVD players, satellite receivers, camcorders, audio equipment, lighting systems, HVAC systems, home security systems, and many more. In addition, the network can interconnect such appliances and building systems with external signal sources such as telephone lines, CATV signals, antennas, satellite feeds, broadband Internet connections and the like. The network allows such media appliances, building systems and signal sources (collectively referred to herein as “media devices”) to communicate with one another and is capable of distributing many types of data such as audio, video, telephone, security, HVAC, and computer data. As is described in more detail below, the network includes a plurality of programmable modules interconnected by fiber optic cables. The modules are designed to transfer any type of media device signal to any location in the network.

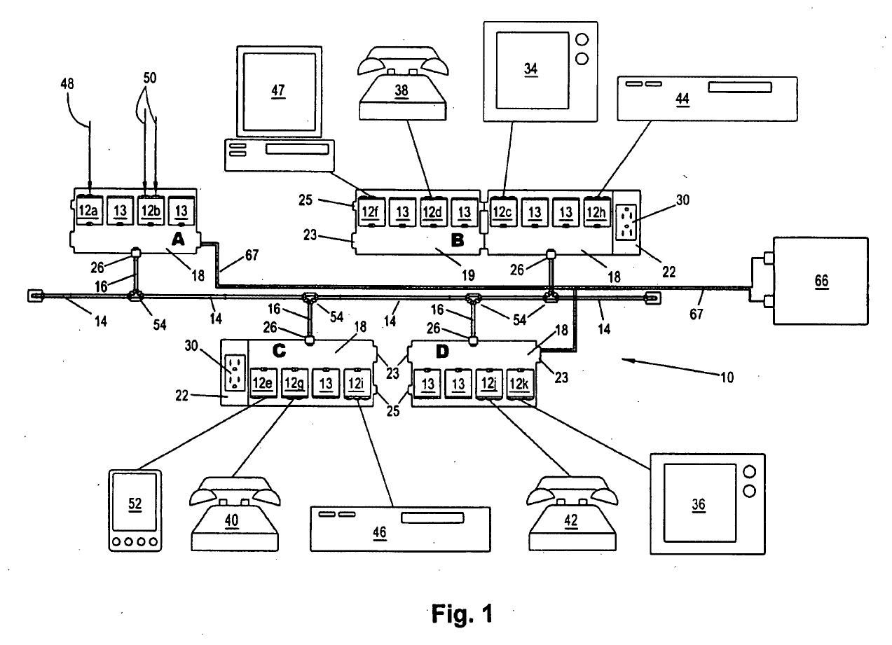

Referring to the drawings wherein identical reference numerals denote the same elements throughout the various views, FIG. 1 shows one exemplary embodiment of a system for distributing data between a plurality of media devices located throughout a building. The system configuration of FIG. 1 is shown for purposes of illustration only; it should be understood that the present invention is not limited to this particular system, as many other configurations and network topologies are possible.

The data distribution system includes a decentralized, multimedia network 10 having eleven programmable modules 12a-12k, a fiber optic backbone or trunkline 14, and a plurality of fiber optic branches 16. The system can also include one or more blank or loop-back plugs 13. The modules 12a-12k are separated into four different groups, with each group being situated in a different location in the building. For example, the groups could be located in different rooms. Alternatively, two or more groups could be located at different sides of the same room. The modules 12a-12k of each group are mounted in respective slots of a module chassis assembly that is installed within a wall, floor or ceiling of the building. One of the blank plugs 13 is inserted in each chassis slot that does not have a module. The blank plugs 13 can later be switched out for a programmable module as needed. By way of example only, four chassis assemblies A, B, C, and D are shown in FIG. 1. Each chassis assembly includes a base chassis 18 and can optionally include an expansion chassis 19 (as shown in FIG. 1, only chassis assembly B has an expansion chassis) connected to the base chassis 18. The expansion chassis 19 are electrically connected to the corresponding base chassis 18 and provide a means for easily expanding the capacity of a chassis assembly after the initial installation. Multiple expansion chassis 19 can be used in a single chassis assembly. The chassis assemblies are cosmetically covered with wall plates (not shown) for a pleasing appearance.

The chassis 18, 19 are open boxes similar to standard electrical gang boxes and are provided with one or more slots for interchangeably receiving modules. Generally, each chassis 18 and expansion chassis 19 is comprised of four slots and is comparable in size to a single gang electrical junction box, although the chassis 18, 19 can be available in several sizes depending on the number of modules to be used

The chassis assemblies can optionally be provided with a power supply chassis 22 containing a power supply (not shown in FIG. 1) for powering the modules and an AC receptacle 30 (such as an 120VAC duplex receptacle) for appliance power connections. By way of example, FIG. 1 shows chassis assemblies B and C being provided with a power supply chassis 22. As an alternative to individual power supplies, the chassis assemblies can be connected to a centrally located power supply 66 connected to the base chassis 18 via cables 67. For example, FIG. 1 shows chassis assemblies A and D connected to the centrally located power supply 66 for powering the modules therein. It should be noted that instead of a combination of chassis assemblies having individual power supplies and chassis assemblies sharing a centrally located power supply, the present invention could have all chassis assemblies provided with individual power supplies or all chassis assemblies sharing a centrally located power supply.

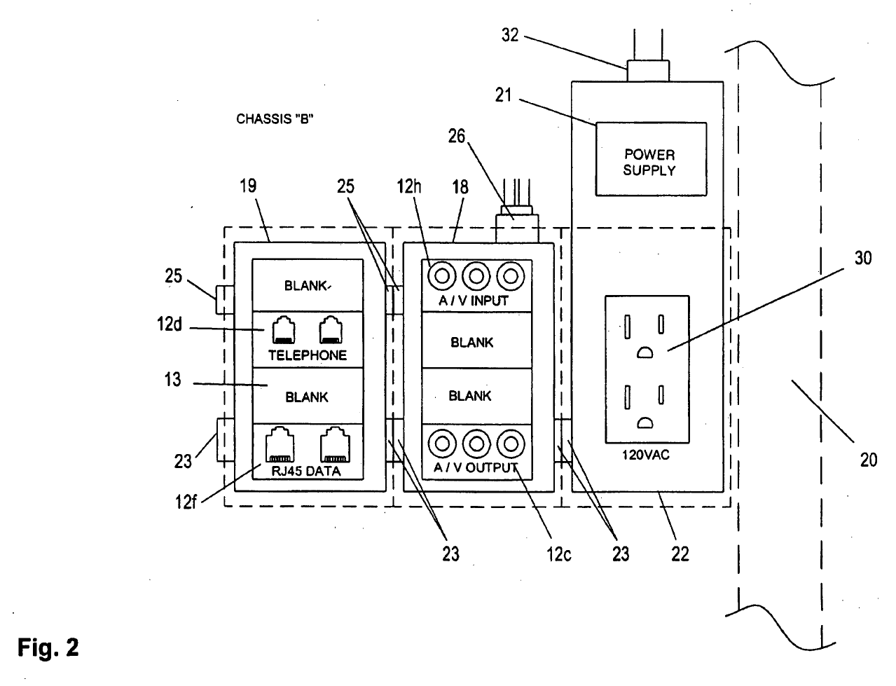

Turning to FIG. 2, chassis assembly B is shown attached to a building stud 20 for a wall mounting. Although a wall-mounted chassis assembly is shown here, it should be noted that floor-mounted and ceiling-mounted chassis would be constructed in the same manner. In the illustrated embodiment, a power supply chassis 22 is attached to the stud 20, a base chassis 18 is attached to the power supply chassis 22, and an expansion chassis 19 is attached to the base chassis 18. The power supply chassis 22 can be attached to the stud 20 with nails, screws or similar fasteners in the same manner that electrical gang boxes are attached to studs. In chassis assemblies not having a power supply chassis, the base chassis 18 would be directly attached to the stud. A power supply, in the form of a power converter 21, with power supply connections for each module, is mounted in the power supply chassis 22. As mentioned above, the power supply chassis 22 also can contain an 120VAC duplex receptacle 30 for appliance power connections. The receptacle 30 is connected to an 120VAC supply line 32.

The base chassis 18 is connected to the power supply chassis 22 by interconnecting power bus connectors 23. The power bus connection transmits power from the power supply to the base chassis 18. The base chassis 18 shown in FIG. 2 contains four modules, by way of example. A duplex fiber optic connector 26 is mounted on the base chassis 18 for connecting the base chassis 18 to the corresponding fiber optic branch 16. As will be described in more detail below, the fiber optic connector 26 is connected to fiber optic connections for each module. Except for the number of modules, all base chassis 18 are essentially the same. The expansion chassis 19 is connected to the base chassis 18 by interconnecting power bus connectors 23 and interconnecting data bus connectors 25. The power bus connection transmits power from the base chassis 18 to the expansion chassis 19, and the data bus connection transmits data from the base chassis 18 to the expansion chassis 19. The expansion chassis 19 shown in FIG. 2 contains two modules, by way of example. Additional expansion chassis would be connected to the expansion chassis 19 by the other power bus connectors 23 and data bus connectors 25. Except for the number of modules, all expansion chassis 19 are essentially the same. The dashed lines in FIG. 2 represent wall plates that would cover the various chassis.

Referring again to FIG. 1, the network 10 further includes first and second televisions 34 and 36 situated in different locations in the building, first, second and third telephones 38, 40 and 42 situated in three different locations, a DVD player 44, a VCR 46, and a computer 47. The first television 34 is connected to module 12c, and the second television 36 is connected to module 12k. The first, second and third telephones 38, 40 and 42 are connected to modules 12d, 12g, and 12j, respectively. The DVD player 44 is connected to module 12h, the VCR 46 is connected to module 12i, and the computer 47 is connected module 12f. It is again noted that the present invention is not limited to these particular devices, as many different types of media devices can be employed.

Module 12a is utilized as a broadband gateway and is connected to an incoming CATV cable 48 that feeds a cable TV signal to the building. As an alternative to a CATV signal, module 12a could be connected to other signal sources such as a TV antenna, a satellite dish feed, or a broadband Internet connection. It is also possible to utilize multiple broadband gateway modules to provide two or more different types of incoming signal sources. Module 12b is utilized as a telephone gateway and is connected to incoming telephone lines 50. Two telephone lines 50 are shown in FIG. 1, but it is possible to provide connections for additional lines. Typically, the chassis 18 containing the gateway modules is located where the external signal connections are made to the building.

The system can optionally include a control device 52 for configuring and controlling the modules. The control device 52 is preferably a handheld wireless terminal such as a personal digital assistant (PDA) or palm top computer, although a hard-wired device could be used as well. The control device 52 communicates with module 12e, which is a wireless transceiver module. As will be described in more detail below, the control device 52 has software that enables the various modules to be programmed to determine where the various signals are to be sent and received from. The control device 52 is used to logically connect media devices that are connected to the network 10 anywhere within the building. For example, the video and audio signals from the VCR 46 can be sent to the first television 34 and/or the second television 36, even if the three media devices are in three different rooms. The signal routing can be changed on the fly using the control device 52.

The fiber optic backbone 14 and branches 16 are preferably duplex multimode fiber optic cables. While FIG. 1 shows a single backbone 14, it should be noted that the network 10 could include a number of interconnected backbones. For example, in a multi-story building, a backbone running from one end of the building to the other could be installed within each floor level. Then, in each room, or wherever a connection to the network 10 was desired, one or more chassis assemblies could be installed in the wall, floor or ceiling. Each chassis assembly is connected to the fiber optic backbone 14 by a corresponding one of the fiber optic branches 16. Each branch 16 is connected to the backbone 14 by a fiber optic tee connector 54. The other end of each branch 16 is connected to its respective fiber optic connector 26 or a fiber optic hub and/or switch.

Each module 12a-12k is designed to be one of three types: input modules, output modules and bidirectional modules. Input modules receive signals from media devices (such as appliances or external sources), convert the signals to data, encode the data, and send the data out to the network 10. Output modules receive encoded data from the network 10, decode the data, and then convert the data to a signal that can be used by a connected media device. Bidirectional modules, which are primarily used for telephone and computer applications, can send and receive data at the same time.

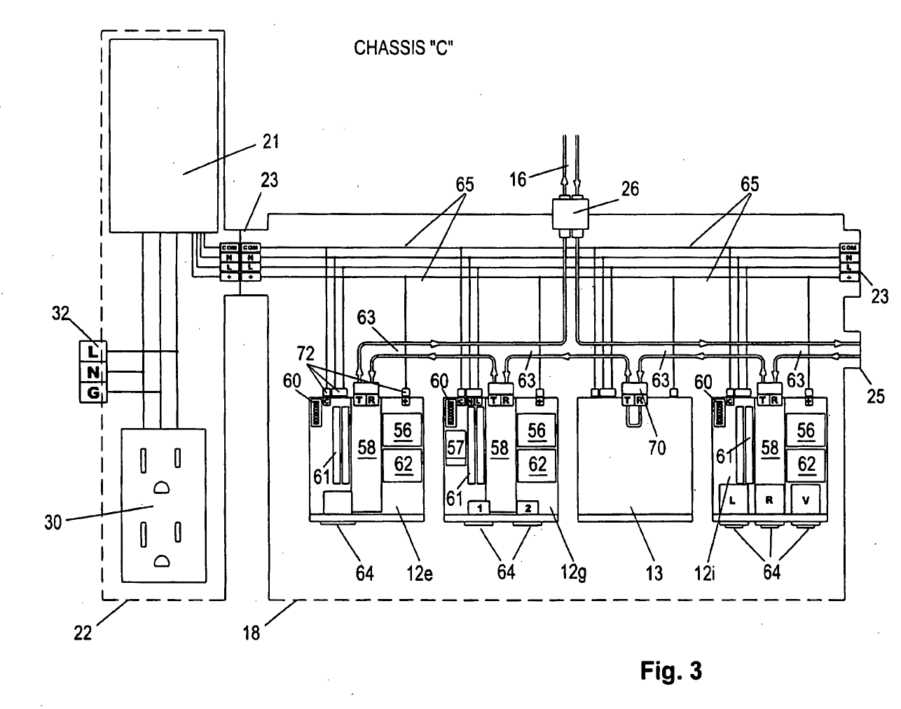

Referring to FIG. 3, which shows modules 12e, 12g and 12i of chassis assembly C by way of example, each one of the programmable modules includes a microprocessor 56, a fiber optic transceiver 58, a DIP switch 60 for manual module addressing, one or more data buffers 61, and a signal converter chip 62. Modules can also include analog telephone circuitry 57, when needed (see module 12g). The fiber optic connector 26 of the chassis assembly is connected in series to the fiber optic transceiver 58 of each module and the chassis' data bus connector 25 by a series of fiber optic cables 63. The blank or loop-back plug 13 includes fiber optic couplers for completing connections of the fiber optic cables 63. A loop-back terminator (not shown) would be connected to the data bus connector 25 if no expansion chassis 19 is connected thereto. As mentioned above, the base chassis 18 is connected to the power supply chassis 22 by interconnecting power bus connectors 23. This connects a power bus 65 in the chassis 18 to the power supply 21. The power bus 65, which can be incorporated on a printed circuit board, includes AC line, AC neutral, DC positive and common bus lines.

The signal converter chip 62 in an input module is an analog-to-digital converter, and is a digital-to-analog converter in an output module. The signal converter chips 62 are preferably 10-bit A/D or D/A converters; the DIP switch 60 is preferably a 16-position DIP switch. Each module also includes one or more signal channels. For example, modules 12c, 12h, 12i and 12k comprise one channel for audio and another channel for video. Modules 12d, 12g and 12j comprise two channels for telephone signals. Module 12f comprises two channels for RJ45 data signals. The modules are also provided with appropriate jacks or connectors 64 for each signal channel. Possible types of connectors include, but are not limited to, A/V input connectors, A/V output connectors, telephone connectors, RJ45 connectors, S-Video connectors, coaxial cable connectors, serial connectors, USB connectors, and the like. In the case of module 12e, which interacts with the control device 52, the connector 64 is preferably an embedded antenna, such as the type commonly used with cordless telephones.

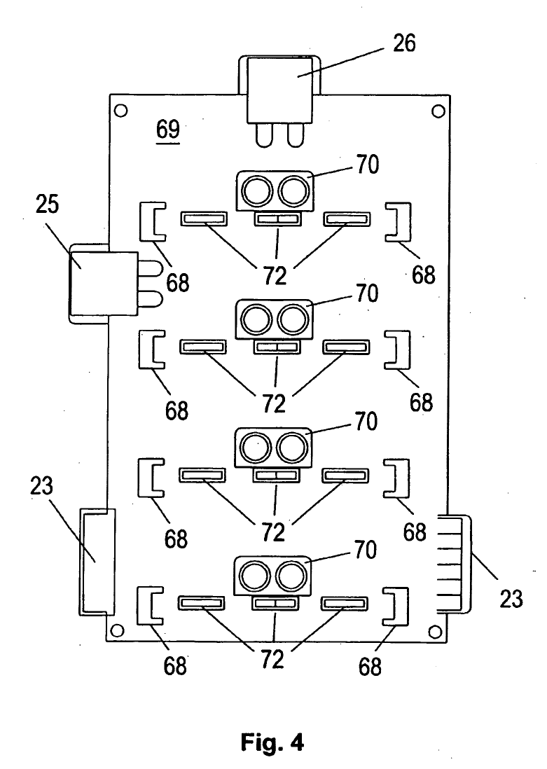

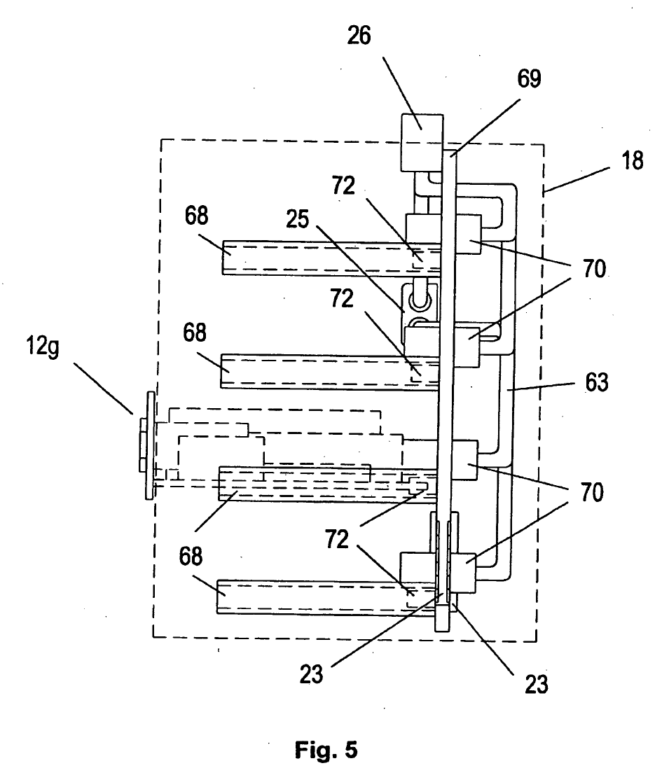

Referring to FIGS. 4 and 5, a representative base chassis 18 is shown in detail. As mentioned above, the base chassis 18 are open boxes similar to standard electrical gang boxes and are provided with a number of rails 68. The rails 68 are arranged into a series of spaced-apart pairs with each pair of rails 68 defining a slot for interchangeably receiving a module. The modules are interchangeably installed into the chassis slots. That is, the modules are uniformly sized so that any module will fit into any chassis slot. The modules are also sized to fit snugly in the slots while still being easily removed by a user. The chassis 18 has a backplane 69 incorporating a data bus connector 70 and a plurality of power bus connectors 72 associated with each slot. The data bus connectors 70 are joined to the fiber optic cables 63 and the power bus connectors 72 are joined to the power bus 65. Specifically, the central power bus connector is connected to the line and neutral lines of the power bus 65, the left power bus connector is connected to the common reference lines, and the right power bus connector is connected to the positive line. When a module is inserted into a slot, the fiber optic transceiver 58 of the module engages the data bus connector 70, thereby connecting the fiber optic transceiver 58 and the fiber optic cables 63, and the positive and negative terminals and the analog telephone circuitry (if present) of the module engage the respective power bus connectors 72, thereby connecting the module to the power bus 65. The expansion chassis 19 are similarly configured with slots, data bus connectors and power bus connectors for interchangeably receiving modules.

When initially setting up the system, the operator selects an appropriate module for each media device that is to be connected to the network 10. Each individual module is addressed, either manually using the modules' DIP switches 60 or automatically using the control device 52 in a manner described below. The modules are then plugged into the designated chassis 18, 19, and the media devices are connected to the connectors 64 of the appropriate modules. The modules 12a-12k are “hot-swappable” so that they power up (via power bus connectors 72) when plugged into a chassis slot.

Manual module addressing is used only when the control device 52 is not used. Manually controlling the system via DIP switches 60 is accomplished using a binary addressing system. In one possible approach, switches 1-8 of the 16-position DIP switch are used to define the module address and switches 9-16 are used to route the module's signal (i.e., define to which module signals are routed). For example, using (1) for the DIP switch ON position and (0) for the DIP switch OFF position, a fifth module's DIP switch would be set as 0000110000000101 to route a signal from the fifth module to a twelfth module, reading from right to left as switches 1-16.

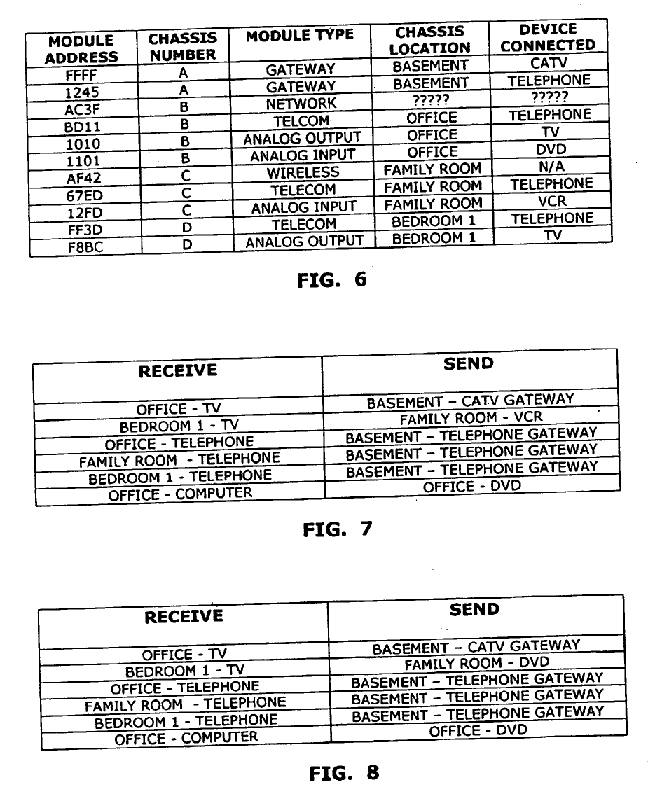

When using the optional control device 52 to configure the system, an interrogation command is sent by the control device 52. Specifically, the operator starts the software program on the control device 52. The control device 52 will display a main menu including a Configuration menu. When the operator selects the Configuration menu from the main menu, the control device 52 will automatically send an interrogation command to the modules on the network 10 to send their respective chassis, slot numbers, device addresses and device types via the wireless transceiver module 12e. The wireless transceiver module 12e sends the collected module information to the control device 52. The control device 52 stores this data in a file table; FIG. 6 illustrates a file table for the system of FIG. 1. For each module, the file table includes the module address, the chassis in which the module is installed (i.e., chassis location), the module type, and the device connected to the module.

Each time a module is placed into a module chassis, a unique module address or ID will be assigned to the module automatically. The module ID or address will be transparent to the operator, as the only data the operator will see is the chassis ID, slot number, and the type of module that resides in the respective chassis slot. The operator must select from a drop down list the device that is connected to each module connected to the system. Each time a new module is placed into the system, the operator will automatically be prompted to enter the configuration routine.

Once the modules and chassis locations are configured, the operator sets where the various signals are to be routed in the network 10. In other words, the operator sets the signal routing. The signal routing determines where input signals from the DVD player 44, the VCR 46, the CATV cable 48 and the telephone lines 50 are sent, and therefore determines what is shown on the first and second televisions 34, 36.

To set the signal routing, the operator selects the Routing command from the main menu list. In response, the control device 52 displays a list of configured output devices and the current signal routings, if any. FIG. 7 illustrates a sample signal routing list in which the signal routings for the first and second televisions 34 and 36, the first, second and third telephones 38, 40 and 42, and the computer 47 are provided. In one column, the signal routing list shows the devices receiving signals and their chassis locations; in the other column, the signal routing list shows the corresponding devices or external sources from which signals are sent and their chassis locations. In this case, the first television set 34, which is connected to module 12c at chassis location B, receives its signal from the CATV cable 48 connected to module 12a at chassis location A. The second television 36, which is connected to module 12k at chassis location D, receives its signal from the VCR 46 connected to module 12i at chassis location C. Each of the telephones 38, 40 and 42 (at chassis locations B, C and D, respectively) receives their signals from the telephone lines 50 connected to module 12b at chassis location A. The computer 47, which is connected to module 12f at chassis location B, receives input from DVD player 44 connected to module 12h, also at chassis location B. By way of example, chassis location A is located in the basement, where the external signal connections are made to the building, chassis location B is in the room being used as a home office, chassis location C is in the family room, and chassis location D is in a bedroom. Signal routings are not limited to a display list. Signal routing from one device to another may be represented graphically; e.g., an icon representation of a television or DVD player may be displayed with lines, representing the signal route, interconnecting them. The operator would select a line to add or delete or simply drag and drop the icons from one to another.

To change any of the signal routes, the operator selects the Edit Routing command on the main menu list, causing the current signal routing list to be displayed on the control device 52. Selected signal routings can be password protected by the operator before a signal routing can be altered. The operator then selects the device for which routing is desired to be changed, and a pop-up menu listing all possible signal sources will be displayed. The operator selects the desired signal source from the pop-up menu to complete the change. For example, the operator could change the signal source for the second television 36 from the VCR 46 to the DVD player 44 by selecting BEDROOM 1—TV from the “RECEIVE” column in the signal routing list. The operator would then select the DVD player in the pop-up menu that would appear. As shown in FIG. 8, the field in the signal routing list corresponding to BEDROOM 1—TV would now read FAMILY ROOM—DVD to show that the second television 36 would now be receiving its signal from the DVD player 44 connected to module 12h at chassis location C.

The programmable modules utilize a peer-to-peer communication architecture, as opposed to a client/server model. That is, each module has roughly equivalent capabilities and responsibilities. Data is sent between modules in data packets. The protocol can be any one of many commercially available protocols, such as Ethernet. With any protocol, the data packet will be comprised of an address, data for specific media, and a checksum or data validity check. Data packets will be optimized to handle high throughput requirements.

In the illustrated embodiment, communication between modules in the network 10 follows a Token Ring topology. Thus, all of the modules are connected by the fiber optic cables in a ring. A token, which is a special series of bits, travels around the ring. This is the preferred method of transporting data, but the present invention is not limited to this topology. An Ethernet topology utilizing hubs and switches could also be used. To send a data packet, a module receives the token, attaches the data packet, and then lets the token continue to travel around the network 10. Each module that sends a data packet will need to receive a packet back before it sends another. The output and bidirectional module types are the initiators of communications between modules, because the devices connected thereto can only receive one signal source at a time.

In operation, each input module runs a diagnostic routine each time it powers up. If diagnostics pass, the module's tri-color LED is green. If a module fails diagnostics, its LED will be red indicating that the module should be replaced. An enable signal is sent to the A/D converter when the input module completes and passes its diagnostics. Data from the A/D converter channels are buffered in a FIFO stack within the signal buffer memory waiting for a release command from the microprocessor. The stack overflows and drops that first data in, so the signal buffer memory only retains the most recent signal data. The module microprocessor then waits for an interrogation command from an output module requesting data. At this point, the module will not send any signal data until it receives a command packet from an output module requesting data. Once the input module receives a request command and a token, it then sends its address information along with signal data to the requesting output module.

Signal data is sent by the input module in response to an external command from an output module requesting signal data. Data is removed from the FIFO stack and is arranged accordingly for output to the specific device needs. The requesting output module's address is added to the data and packaged. The data packet is then sent to the fiber optic transceiver of the input module for output to the network 10.

Operation of the output modules also starts with a diagnostic routine each time a module powers up. If diagnostics pass, the module's tri-color LED is green. If a module fails diagnostics, its LED will be red indicating that the module should be replaced. An enable signal is sent to the D/A converter when the output module completes and passes its diagnostics. Once the output module passes diagnostics and determines that an output device is externally connected, the microprocessor determines which input to request data from. When the token arrives, a command packet is constructed and sent to the appropriate input module requesting its signal data.

The output module processes every data packet that arrives to determine if the packet is intended for the output module. The module's transceiver starts to receive packets with its address; all other packets are ignored. The data of the accepted data packets is checked for validity. If the data is valid, the address information is stripped off and the data is sent to a cache buffer, three registers at a time. When the FIFO buffer fills and overflows, the overflow is sent to the D/A converter for output to the connected device.

While specific embodiments of the present invention have been described, it will be apparent to those skilled in the art that various modifications thereto can be made without departing from the spirit and scope of the invention as defined in the appended claims.

1. A modular multimedia data distribution system comprising:
a plurality of modules interconnected in a peer-to-peer architecture by fiber optic cables wherein data can be sent directly from one module to another, each module having means for connecting said module to a media device;
at least one of said modules further including:
means for receiving signals from media devices;
means for converting received signals into data; and
means for sending data to at least one other one of said modules; and
at least one of said modules further including:
means for receiving data from other modules;
means for converting received data into signals; and
means for sending signals to a media device.

2. The system of claim 1 wherein each module includes a fiber optic transceiver for connecting said module to one of said fiber optic cables.

3. The system of claim 1 wherein each module includes a DIP switch for manual module addressing.

4. The system of claim 1 further comprising a control device for configuring and controlling said modules.

5. The system of claim 4 wherein said control device is a handheld wireless terminal that communicates with one of said modules.

6. The system of claim 1 further comprising a power supply connected to each module.

7. A modular multimedia data distribution system comprising;
a plurality of modules interconnected by fiber optic cables wherein data can be sent directly from one module to another, each module having means for connecting said module to a media device; and
a plurality of chassis, each chassis having at least one slot for interchangeably receiving a module and each slot having means for connecting a module to one of said fiber optic cables.

8. The system of claim 7 wherein each module includes a fiber optic transceiver that engages said means for connecting a module to one of said fiber optic cables when a module is inserted into a slot.

9. The system of claim 7 wherein each module includes a DIP switch for manual module addressing.

10. The system of claim 7 wherein each module includes a DIP switch for manual module addressing.

11. The system of claim 7 further comprising a control device for configuring and controlling said modules.

12. The system of claim 11 wherein said control device is a handheld wireless terminal that communicates with one of said modules.

13. The system of claim 7 further comprising a power supply connected to one or more of said modules.

14. The system of claim 13 wherein each slot includes means for connecting a module inserted into said slot to said power supply.

15. The system of claim 13 further comprising a power supply chassis connected to one of said plurality of chassis, said power supply being mounted in said power supply chassis.

16. The system of claim 15 further comprising an AC receptacle mounted in said power supply chassis.

17. The system of claim 7 further comprising at least one expansion chassis connectable to any one of said plurality of chassis.

18. The system of claim 7 wherein said chassis are distributed throughout a building.

19. The system of claim 7 wherein said chassis are distributed throughout a building having a plurality of rooms, each chassis being located in a different one of said rooms.
